(19) United States
(12) Patent Application Publication
(10) Pub. No.: US 2021/0029478 A1
(43) Pub. Date: Jan. 28, 2021

(54) AUTOMATIC SYSTEM ADJUSTMENT OF AUTOMOBILE SYSTEM BASED ON DETECTION OF HEAD POSITION

(71) Applicant: Panasonic Automotive Systems Company of America, Division of Panasonic Corporation of North America, Peachtree City, GA (US)

(72) Inventor: JONATHAN RICHARD LANE, WHITMORE LAKE, MI (US)

(73) Assignee: Panasonic Automotive Systems Company of America, Division of Panasonic Corporation of North America

(21) Appl. No.: 16/933,275

(22) Filed: Jul. 20, 2020

Related U.S. Application Data
(60) Provisional application No. 62/876,975, filed on Jul. 22, 2019.

(51) Int. Cl. H04R 29/00; H04R 3/04; H04R 1/02

(52) U.S. Cl. CPC H04R 29/001; H04R 2499/13; H04R 1/025; H04R 3/04

(57) ABSTRACT

An audio arrangement for a motor vehicle includes a position sensor detecting a position of ears of a human driver of the motor vehicle. A memory device stores sets of audio parameters. Each set of audio parameters is stored in association with a corresponding possible position of the ears of the human driver. An electronic controller receives a position signal from the position sensor indicative of the detected position of the ears of the human driver. The electronic controller retrieves from the memory device a set of audio parameters stored in association with the detected position of the ears of the human driver. The electronic controller transmits an audio signal dependent upon the retrieved set of audio parameters. An audio system receives the audio signal from the electronic controller. The audio system produces audible sounds dependent upon the received audio signal.

### CROSS-REFERENCED TO RELATED APPLICATIONS

This application claims benefit of U.S. Provisional Application No. 62/876,975, filed on Jul. 22, 2019, the disclosure of which is hereby incorporated by reference in its entirety for all purposes.

### BACKGROUND OF THE INVENTION

### 1. Field of the Invention

The present invention relates to audio systems and, more particularly, to audio systems implemented in a motor vehicle.

### 2. Description of the Related Art

Normally, when an audio (sound) system has a variation in performance due to variations in the driver's head (eye, ear, etc.) position, an average adjustment must be arrived at based on some selection of individual performance measures over the range of possible head positions. Usually, the average adjustment is based on the range of human heights (e.g., some percentile of the average). This invention allows for the automatic selection of the optimum performance for variations in human height.

FIG. 1 illustrates a range of possible head positions of different drivers in a motor vehicle as known in the prior art. The differences in the head positions may be due mainly to the differences in heights of the drivers; they may also be due to an adjustment of seating position based on comfort or control access.

FIG. 2 illustrates system responses for each of the head positions shown in FIG. 1, according to the prior art. As is evident from the differences between the responses, the system response for a given sound system arrangement is dependent upon the position of the driver's head due to the acoustic properties of the passenger compartment of the motor vehicle that the drivers sit in.

FIGS. 3A and 3B illustrate known methods of measuring an average acoustic response for each of the head positions shown in FIG. 1. A six-microphone array system may be used to measure the vehicle audio system. A common alternative system utilizes a binaural dummy head with two microphones in the ear positions. Test inputs are sent to measurement equipment. A single result of the spatially averaged response may be used to make a single set of parameters for adjusting the audio system. Such an average response is shown in FIG. 4. This measurement, combined with other objective and subjective evaluation means are used to reach a satisfactory average performance over the range of seating positions. The single parameter set may be implemented in an amplifier with customized sound compensation settings to optimize the average response.

By using the above-described average-gathering system and associated performance adjustment equipment (e.g., a customizable amplifier for audio), a single optimizing parameter set is made for a range of listener's (driver's) head positions. Therefore, the response at each different head position is not optimum, as is evident from FIG. 2.

### SUMMARY OF THE INVENTION

The invention may automatically adjust the performance-modifying parameters of an audio (sound) system for a range of head positions by detecting the eye position of a listener (e.g., a driver). The listener's eye position may be used as a proxy for the listener's ear position. The listener's eye position may be estimated indirectly through sensing the orientation of the interior rearview mirror. Alternatively, the listener's eye position and/or ear position may be determined more directly through capturing images, or other sensor representations, of the listener's head. This invention enables automatic selection of the optimum performance depending on the estimated or determined ear position of the listener.

The invention comprises, in one form thereof, an audio arrangement for a motor vehicle, including a position sensor detecting a position of ears of a human driver of the motor vehicle. A memory device stores sets of audio parameters. Each set of audio parameters is stored in association with a corresponding possible position of the ears of the human driver. An electronic controller is communicatively coupled to the position sensor and to the memory device. The electronic controller receives a position signal from the position sensor indicative of the detected position of the ears of the human driver. The electronic controller retrieves from the memory device a set of audio parameters stored in association with the detected position of the ears of the human driver. The electronic controller transmits an audio signal dependent upon the retrieved set of audio parameters. An audio system is communicatively coupled to the electronic controller and receives the audio signal from the electronic controller. The audio system produces audible sounds dependent upon the received audio signal, through sound adjustments designed to correct for the effects of the vehicle characteristics.

The invention comprises, in another form thereof, an audio method for a motor vehicle, including detecting a position of ears of a human driver of the motor vehicle. Sets of audio parameters are stored in memory. Each set of audio parameters is stored in association with a corresponding possible position of the ears of the human driver. A position signal is transmitted that is indicative of the detected position of the ears of the human driver. A set of audio parameters stored in association with the detected position of the ears of the human driver is retrieved from the memory device. An audio signal dependent upon the retrieved set of audio parameters is transmitted. Audible sounds are produced dependent upon the audio signal.

The invention comprises, in yet another form thereof, an audio method for a motor vehicle, including measuring a respective audio response at each of a plurality of possible positions of ears of a human driver in the motor vehicle. A respective optimum set of audio parameters is determined for each of the possible positions of ears of the human driver. The determining is at least partially dependent upon the measured audio responses. The optimum sets of audio parameters are stored in memory. Each optimum set of audio parameters is stored in association with the respective possible position of the ears of the human driver. An actual position of ears of an actual human driver of the motor vehicle is detected. A position signal indicative of the detected actual position of the ears of the actual human driver is transmitted. A set of audio parameters stored in association with a possible position of the ears that best matches the detected actual position of the ears of the actual human driver is retrieving from the memory device. An audio signal dependent upon the retrieved set of audio parameters is transmitted. Audible sounds are produced dependent upon the audio signal. An intermediate setting might be obtained by interpolation.

An advantage of the invention is that it may enable an audio system to be optimized for a current position of a driver's head.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a diagram of a range of possible head positions of different drivers in a motor vehicle as known in the prior art.

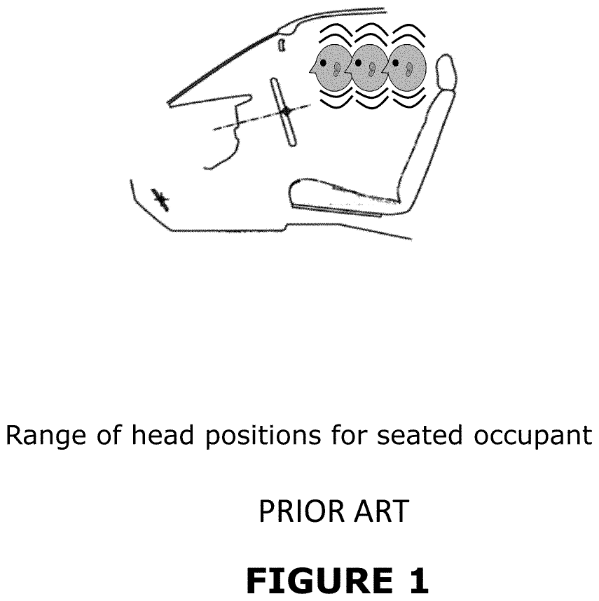

FIG. 2 is a plot of system responses for representative head positions at the middle and full forward and rearward seating positions shown in FIG. 1 as known in the prior art.

FIGS. 3A& 3B are diagrams of known methods of measuring an average acoustic response for each of the head positions shown in FIG. 1.

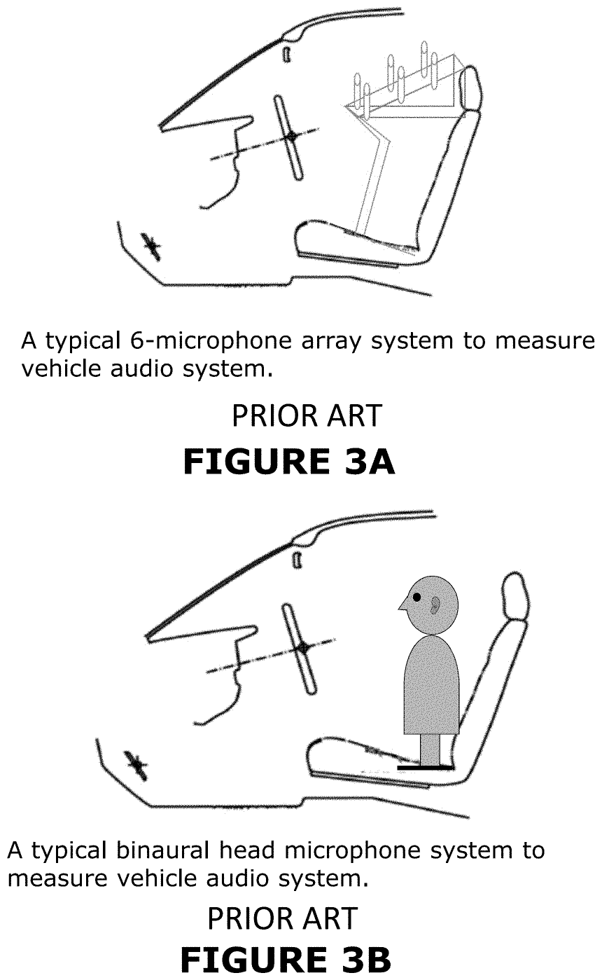

FIG. 4 is a plot of a spatially averaged response measured by use of the methods of FIG. 3A or FIG. 3B.

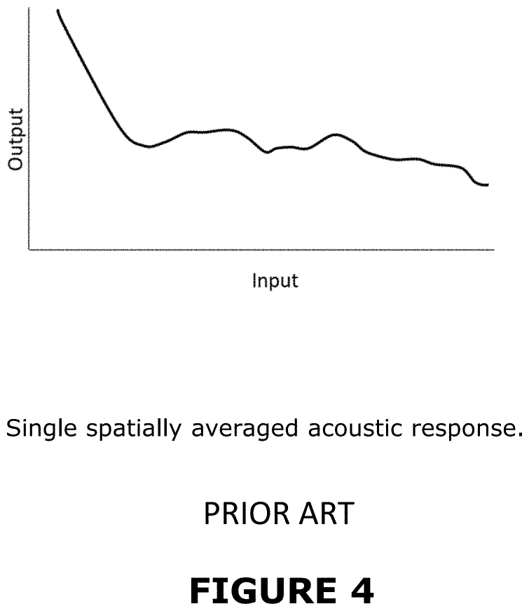

FIG. 5 is a diagram of one step of one embodiment of a method of the present invention for operating an audio system.

FIG. 6 is a diagram of a further step of the embodiment using the information acquired in the system of FIG. 5.

FIG. 7 is a plot of an example audio response achieved by use of the method of the present invention.

FIG. 8 is a block diagram of one embodiment of an automotive audio system of the present invention.

FIG. 9 is a flow chart of one embodiment of an audio method of the present invention for a motor vehicle.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

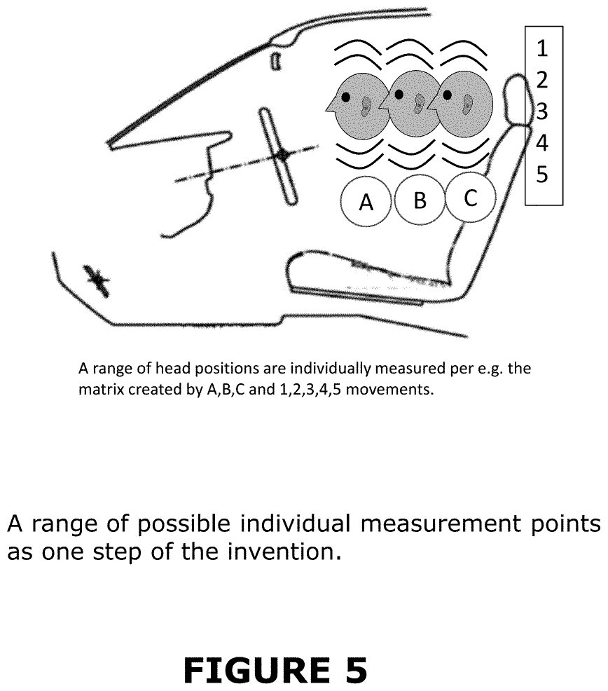

FIG. 5 is a diagram of one embodiment of a method of the present invention for operating an audio system. Test inputs are sent to measurement equipment, and the response for each head position is individually measured. An appropriate individual correction parameter set is established for each head position separately for optimum performance. Each position measurement may be used to make a custom parameter set for each respective listener's (driver's) head position. Each head position gets an individually correct parameter set. Multiple correction parameter data sets may result from using individual measurements and adjustments. Depending on the driver's head position, as may be determined by the manually adjustable orientation of the rearview mirror at the top edge of the windshield, a camera focused on the driver, or by the seat position setting, the appropriate parameter set is automatically selected by the controller (e.g., a digital signal processor (DSP)).

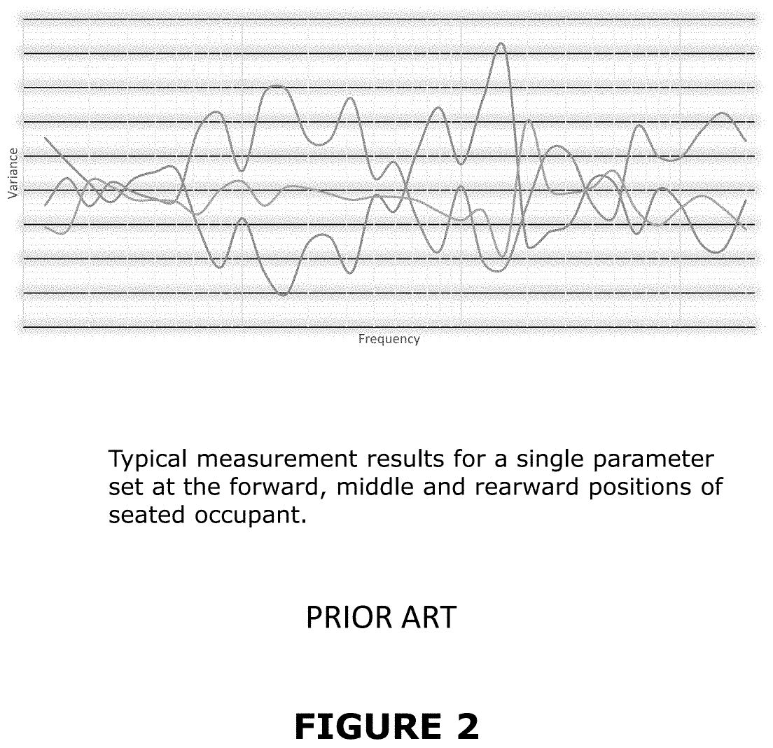

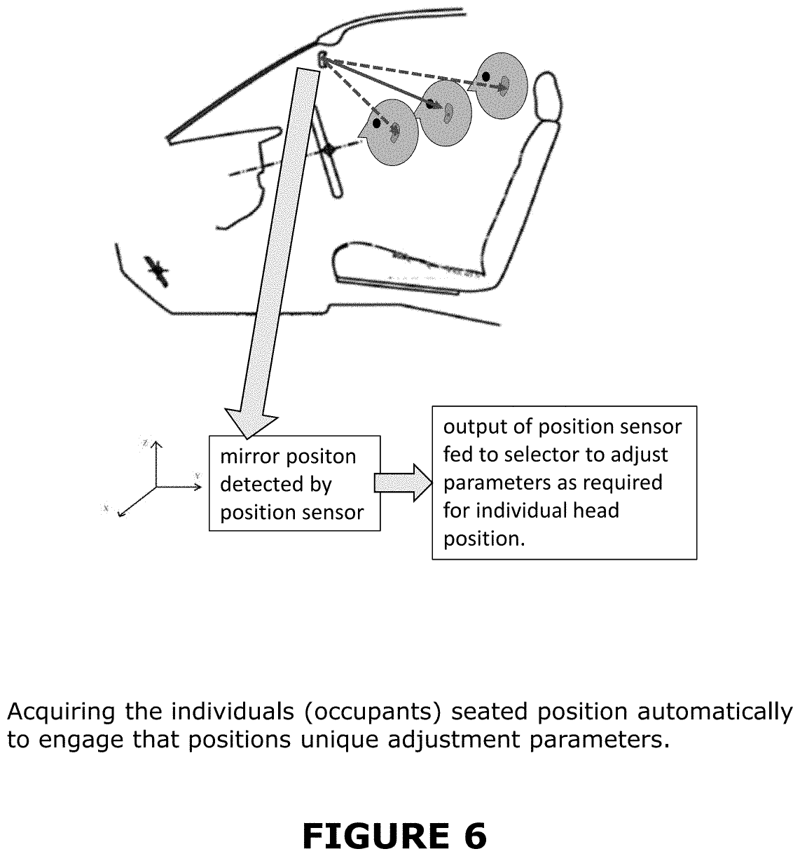

FIG. 6 illustrates one embodiment of another step of the method of FIG. 5. The precise location of the head can be determined by the position or orientation of the rearview mirror. From the location of the head, the locations of the ears may be derived. The position/orientation of the rearview mirror may be detected by a position sensor. The output of the position sensor may be fed to a DSP controller algorithm to adjust parameters as required for the individual unique head position due to variations in the responses associated with the head positions, as plotted in FIG. 2.

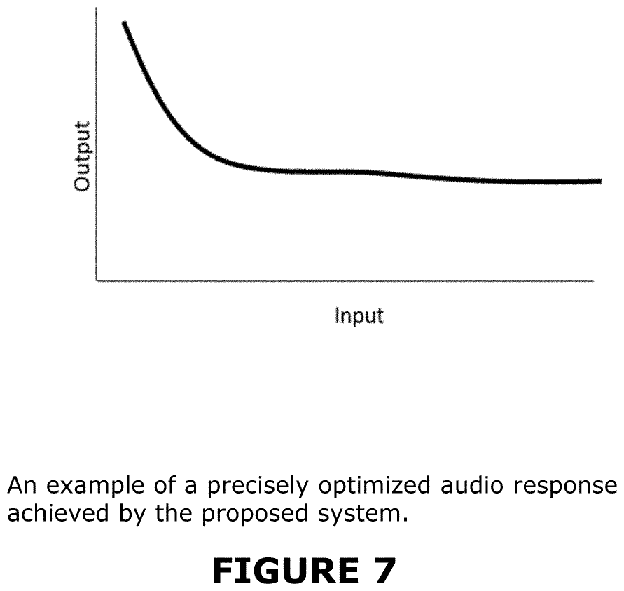

The result is optimum performance for each head position, as shown in the resulting response function plot of FIG. 7. However, it is to be understood that the scope of the invention is not limited to any particular audio response, only one example of which is shown in FIG. 7. Rather, the scope of the invention may broadly encompass any audio parameter optimization dependent upon the driver's head position.

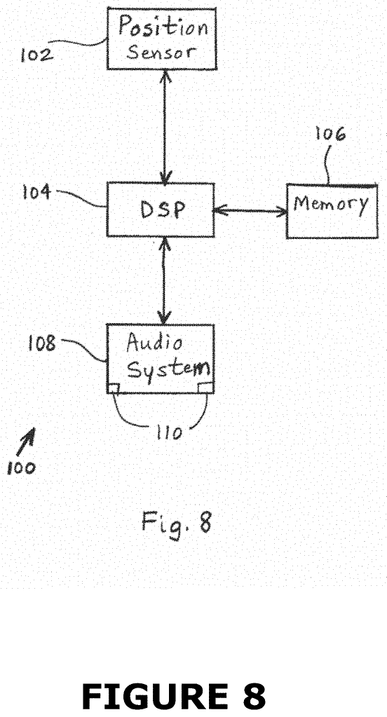

FIG. 8 illustrates one embodiment of an automotive audio arrangement 100 of the present invention, including an ear position sensor 102, a selector 104, a memory device 106, and an audio system 108. Sensor 102 may be a rearview mirror position/orientation sensor that determines the position of the driver's eyes and, thus, the positions of the driver's ears. Sensor 102 may additionally include a driver's seat sensor that detects the position of the driver's seat in forward-reverse directions, up-down directions, and/or tilt rotational directions. Thus, the position and/or orientation of the driver's seat may be a factor in determining the positions of the driver's ears. Alternatively, or in addition, sensor 102 may be a camera that captures images of the driver's head, and, these images may be factors in determining the positions of the driver's ears.

During use, sensor 102 determines the positions of the driver's ears and transmits the ear positions to DSP controller 104. DSP controller 104 may then retrieve optimized parameters for those ear positions from a lookup table in memory device 106. The parameters may include equalization settings and filter settings, for example. DSP controller 104 may use the retrieved optimized parameters to create audio signals that are transmitted to audio system 108. Audio system 108 may convert the audio signals into audible sound by use of loudspeakers 110.

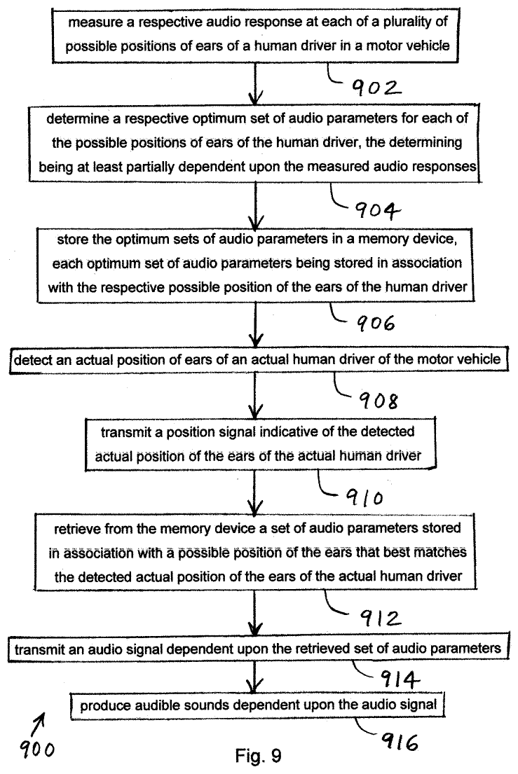

FIG. 9 illustrates of one embodiment of an audio method 900 of the present invention for a motor vehicle. In a first step 902, a respective audio response is measured at each of a plurality of possible positions of ears of a human driver in the motor vehicle. For example, as shown in FIG. 5, the response for each head position is individually measured.

Next, in step 904, a respective optimum set of audio parameters is determined for each of the possible positions of ears of the human driver. The determining is at least partially dependent upon the measured audio responses. For example, an appropriate individual correction parameter set is established for each head position separately for optimum performance.

In a next step 906, the optimum sets of audio parameters are stored in memory. Each optimum set of audio parameters is stored in association with the respective possible position of the ears of the human driver. For example, optimized parameters for each ear position may be stored in a lookup table in memory device 106.

In step 908, an actual position of ears of an actual human driver of the motor vehicle is detected. For example, the driver's actual head position, which may be a proxy for the ear position, may be determined by the manually adjustable orientation of the rearview mirror, by a camera focused on the driver, or by the driver's seat position setting.

Next, in step 910, a position signal is transmitted indicative of the detected actual position of the ears of the actual human driver. For example, ear position sensor 102 may transmit a signal indicative of the ear positions to DSP controller 104.

In a next step 912, a set of audio parameters stored in association with a possible position of the ears that best matches the detected actual position of the ears of the actual human driver is retrieved from the memory device. For example, DSP controller 104 may retrieve optimized parameters for the detected actual ear positions from a lookup table in memory device 106.

In step 914, an audio signal dependent upon the retrieved set of audio parameters is transmitted. For example, DSP controller 104 may use the retrieved optimized parameters to create audio signals that are transmitted to audio system 108.

In a final step 916, audible sounds are produced dependent upon the audio signal. For example, audio system 108 may convert the audio signals into audible sound by use of loudspeakers 110.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. An audio arrangement for a motor vehicle, the arrangement comprising:
a position sensor configured to detect a position of ears of a human driver of the motor vehicle;
a memory device storing sets of audio parameters, each said set of audio parameters being stored in association with a corresponding possible said position of the ears of the human driver;
an electronic controller communicatively coupled to the position sensor and to the memory device, the electronic controller being configured to:
receive a position signal from the position sensor indicative of the detected position of the ears of the human driver;
retrieve from the memory device a set of audio parameters stored in association with the detected position of the ears of the human driver; and
transmit an audio signal dependent upon the retrieved set of audio parameters; and
an audio system communicatively coupled to the electronic controller and configured to:
receive the audio signal from the electronic controller; and
produce audible sounds dependent upon the received audio signal.

2. The arrangement of claim 1, wherein the position sensor comprises a rearview mirror position sensor.

3. The arrangement of claim 1, wherein the position sensor comprises a camera or other image sensor means.

4. The arrangement of claim 1, wherein the position sensor comprises a driver's seat position sensor.

5. The arrangement of claim 1, wherein the audio parameters comprise equalization settings.

6. The arrangement of claim 1, wherein the audio parameters comprise filter and/or signal delay settings.

7. The arrangement of claim 1, wherein the audio system comprises a loudspeaker.

8. An audio method for a motor vehicle, the method comprising:
detecting a position of ears of a human driver of the motor vehicle;
storing sets of audio parameters, each said set of audio parameters being stored in association with a corresponding possible said position of the ears of the human driver;
transmitting a position signal indicative of the detected position of the ears of the human driver;
retrieving from the memory device a set of audio parameters stored in association with the detected position of the ears of the human driver;
transmitting an audio signal dependent upon the retrieved set of audio parameters; and
producing audible sounds dependent upon the audio signal.

9. The method of claim 8, wherein the position of the ears of the human driver is detected by a rearview mirror position sensor.

10. The method of claim 8, wherein the position of the ears of the human driver is detected by a camera or other image sensor means.

11. The method of claim 8, wherein the position of the ears of the human driver is detected by a driver's seat position sensor.

12. The method of claim 8, wherein the audio parameters comprise equalization settings.

13. The method of claim 8, wherein the audio parameters comprise filter settings.

14. The method of claim 8, wherein the audible sounds are produced by a loudspeaker.

15. The method of claim 8, further comprising:
measuring a respective audio response at each of a plurality of possible ear positions of a human driver; and
determining an optimum set of audio parameters for each of the possible ear positions, the determining at least partially being dependent upon the measured audio responses, wherein the determined optimum sets of audio parameters are stored in the storing step.

16. An audio method for a motor vehicle, the method comprising:
measuring a respective audio response at each of a plurality of possible positions of ears of a human driver in the motor vehicle;
determining a respective optimum set of audio parameters for each of the possible positions of ears of the human driver, the determining being at least partially dependent upon the measured audio responses;
storing the optimum sets of audio parameters in a memory device, each said optimum set of audio parameters being stored in association with the respective possible position of the ears of the human driver;
detecting an actual position of ears of an actual human driver of the motor vehicle;
transmitting a position signal indicative of the detected actual position of the ears of the actual human driver;
retrieving from the memory device a set of audio parameters stored in association with a possible position of the ears that best matches the detected actual position of the ears of the actual human driver;
transmitting an audio signal dependent upon the retrieved set of audio parameters; and
producing audible sounds dependent upon the audio signal.

17. The method of claim 16, wherein the position of the ears of the human driver is detected by a rearview mirror position sensor.

18. The method of claim 16, wherein the position of the ears of the human driver is detected by a camera or other image sensor means.

19. The method of claim 16, wherein the position of the ears of the human driver is detected by a driver's seat position sensor.

20. The method of claim 16, further comprising determining a function defining a variation of responses and an appropriate correlated adjustment.
